(19) United States
(12) Patent Application Publication
(10) Pub. No.: US 2025/0111125 A1
(43) Pub. Date: Apr. 3, 2025

(54) DYNAMIC PRESENTATION SLIDE GENERATION AND FORMATTING SYSTEM AND METHOD USING MACHINE LEARNING

(71) Applicant: Integreon, Inc., Fargo, ND (US)

(72) Inventors: Emerson E. Bogñalbal, Mandaluyong City (PH); Saurav Khan, Mumbai (IN); Saravanakumar Chandran, Mumbai (IN); Praveen Venu, Kerala (IN); Sahil Parekh, Mumbai (IN); Ananta Sarathi, Mumbai (IN)

(21) Appl. No.: 18/804,893

(22) Filed: Aug. 14, 2024

(30) Foreign Application Priority Data
Oct. 3, 2023 (IN) 202311066076

(51) Int. Cl. G06F 40/103

(52) U.S. Cl. CPC G06F 40/103

(57) ABSTRACT

Systems and methods are directed to automatically modifying a presentation slide by employing a previously trained machine learning model. A target presentation slide may be selected for modification. A theme is also selected for the target presentation slide. A trained machine learning model is then selected and employed on the target presentation slide based on the theme, which generate at least one recommended modification to the target presentation slide. The target presentation slide is then modified based on the at least one recommended modification.

### BACKGROUND

Presenting information to a group of people can come in many forms. One such presentation form includes the presentation of slides containing information, such as PowerPoint slides. The generation of such presentation slides can be very arduous and time consuming. Not only to users have to come up with the information that goes into the slides, they also have to format each slide correctly. Having different formats and styles can result in unprofessional looking slides. It is with respect to these and other considerations that the embodiments herein have been made.

### BRIEF SUMMARY

Embodiments described herein are directed towards systems and methods to automatically modify a presentation slide by employing a previously trained machine learning model. A target presentation slide may be selected for modification. A theme is also selected for the target presentation slide. A trained machine learning model is then selected and employed on the target presentation slide based on the theme, which re-aligns the content as per the theme or generate at least one recommended modification to the target presentation slide. The machine learning model may be trained by extracting object attributes and slide attributes from a plurality of training slides, and then inputting the extracted attributes into one or more machine learning or artificial intelligence mechanisms. The target presentation slide is then modified based on at least one recommended modification.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for automatically formatting and generating slides in accordance with embodiments described herein;

FIG. 2 is a context diagram of a non-limiting embodiment of a system that provides functionality to automatically formatting and generating slides in accordance with embodiments described herein;

FIG. 3 illustrates a logical flow diagram showing one embodiment of an overview process for automatically formatting and generating slide in accordance with embodiments described herein;

FIG. 4 illustrates a logical flow diagram showing one embodiment of a process for employing machine learning to train a model to automatically format and generate slides in accordance with embodiments described herein; and

FIG. 5 shows a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

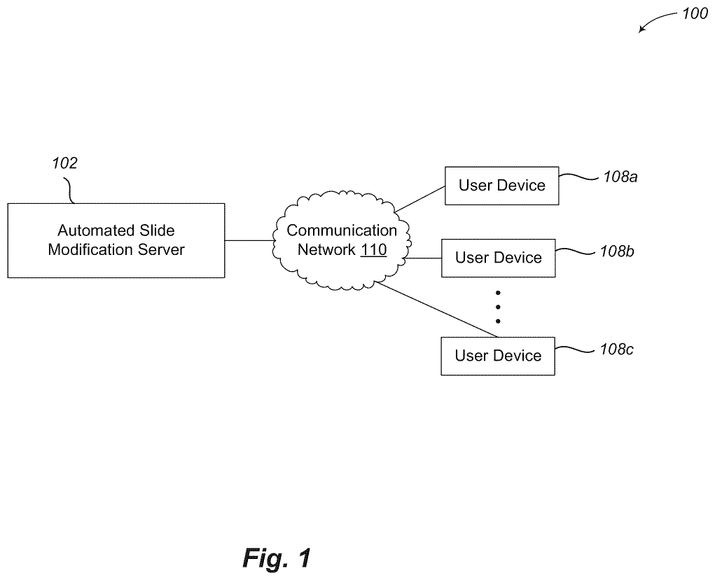

FIG. 1 illustrates a context diagram of an environment 100 for automatically formatting and generating slides in accordance with embodiments described herein. Environment 100 includes automated slide modification server 102 and user devices 108a-108c, which communicate via communication network 110. The communication network 110 is configured to couple various computing devices to transmit content/data from one or more devices to one or more other devices. Communication network 110 may include one or more wired or wireless networks.

User devices 108a-108c are computing devices that are configured to enable a user to generate presentation slides and access the automated slide modification server 102. User devices 108a-108c may include tablet computers, laptop computers, desktop computers, or other computing devices.

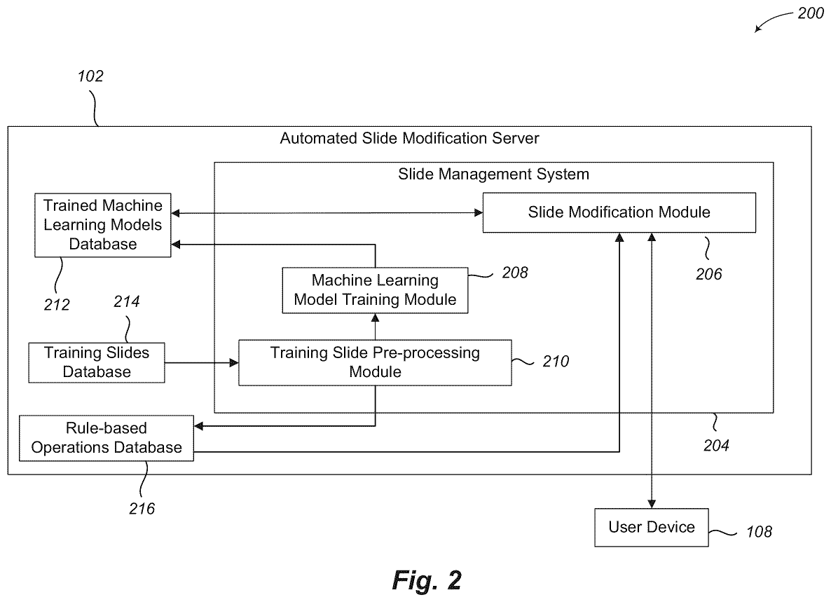

The automated slide modification server 102 is configured to train a machine learning model to predict and make automatic modifications to slides prepared by users of user devices 108a-108c, which is described in more detail herein, including in FIG. 2. Briefly, however, the automated slide modification server 102 is configured to train one or more machine learning models to automatically modify one or more target presentation slides based on a plurality of training slides. The automated slide modification server 102 is also configured to enable a user to select a theme or one or more user-selected operations to perform on one or more target slides. The automated slide modification server 102 utilizes the theme or the user-selected operations as input into the one or more trained machine learning models to make one or more automatic modifications to the one or more target slides.

FIG. 2 is a context diagram of a non-limiting embodiment of a system 200 that provides functionality to automatically formatting and generating slides in accordance with embodiments described herein. System 200 includes the automated slide modification server 102 and a user device 108, which may be embodiments of the components illustrated in FIG. 1.

The automated slide modification server 102 is configured to utilize one or more trained machine learning models to automatically modify or generate one or more target presentation slides. The automated slide modification server 102 includes a slide management system 204. The automated slide modification server 102 may also store or maintain a trained machine learning models database 212, a training slides database 214, and a rule-based operations database 216. Although the trained machine learning models database 212, the training slides database 214, and the rule-based operations database 216 are illustrated as being stored or maintained by the automated slide modification server 102, embodiments are not so limited. In some embodiments, the trained machine learning models database 212, the training slides database 214, and the rule-based operations database 216 may be stored or maintained by one or more other computing devices or databases (not illustrated).

The trained machine learning models database 212 may store or maintain one or more machine learning models that are generated or trained by the machine learning model training module 208. The training slides database 214 may store or maintain a plurality of previously prepared presentation slides in a masked (augmented) format that are to be used by the machine learning model training module 208 to train the machine learning models. And the rule-based operations database 216 may store or maintain one or more rule-based operations that can be used by the slide modification module to modify one or more target slides.

The slide management system 204 includes a slide modification module 206, a machine learning model training module 208, and a training slide pre-processing module 210. Although the slide modification module 206, the machine learning model training module 208, and the training slide pre-processing module 210 are illustrated as separate modules, embodiments are not so limited. In some embodiments, a single module or a plurality of modules may be employed to perform the functionality of the slide modification module 206, the machine learning model training module 208, and the training slide pre-processing module 210.

The training slide pre-processing module 210 is configured to pre-process training slides for use by the machine learning model training module 208. The training slide pre-processing module 210 accesses the training slides database 214 to obtain the training slides. The training slide pre-processing module 210 masks private data in the training slides and extracts various attributes from the training slides. In various embodiments, the training slide pre-processing module 210 extracts slide attributes from the training slides and extracts object attributes from the objects on the training slides. Such attributes can be any modifiable characteristic of a training slide or a slide object, such as position, color, rotation, animation, margins, text typeface, fonts, bullets or numbering, other object formatting, etc. These extracted attributes are provided to the machine learning model training module 208 for use in training the machine learning models.

In some embodiments, the training slide pre-processing module 210 can generate one or more rule-based operations from the extracted attributes. In at least one embodiment, the training slide pre-processing module 210 may employ one or more machine learning or artificial intelligence mechanisms to generate the rule-based operations. These rule-based operations are then stored in the rule-based operations database 216.

The machine learning model training module 208 is configured to receive the pre-processed training slides or pre-processed training slide data (e.g., the extracted attributes) from the training slide pre-processing module 216. The machine learning model training module 208 utilizes one or more machine learning or artificial intelligence mechanisms to train one or more machine learning models from the pre-processed training slides. The machine learning model training module 208 can then store the generated or trained machine learning models in the training machine learning models database 212.

The slide modification module 206 is configured to receive a request from the user device 108 to modify a target presentation slide or to generate a target presentation slide. In some embodiments, the slide modification module may execute or host the presentation application, such as Microsoft® PowerPoint®. In other embodiments, the user device 108 executes or hosts the presentation application and communicates with the slide modification module 206 via an application program interface.

In response to receiving a modification request, the slide modification module 206 determines whether one or more trained machine learning models are employed or whether one or more rule-based operations are performed on the target slide. If the slide modification module 206 is to employ one or more trained machine learning models, the slide modification module 206 accesses or obtains the one or more trained machine learning models from the trained machine learning models database 212. The slide modification module 206 can then use a selected theme or the target slide itself as input into the one or more trained machine learning models to output one or more modification recommendations. The slide modification module 206 can then automatically modify the target slide or generate a new target slide based on the modification recommendations output by the one or more trained machine learning models.

If the slide modification module 206 is to perform one or more rule-based operations, the slide modification module 206 accesses or obtains the one or more rule-based operations from the rule-based operations database 216. The slide modification module 206 can then automatically modify the target slide or generate a new target slide based on the rule-based operations. The slide modification module 206 provides the modified target slide to the user device 108 or displays the modified target slide to a user of the user device 108.

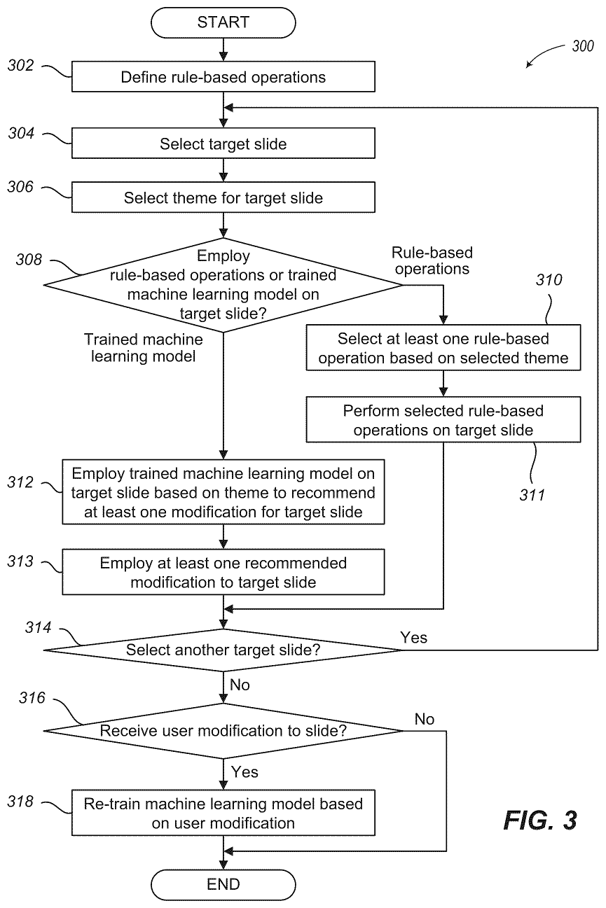

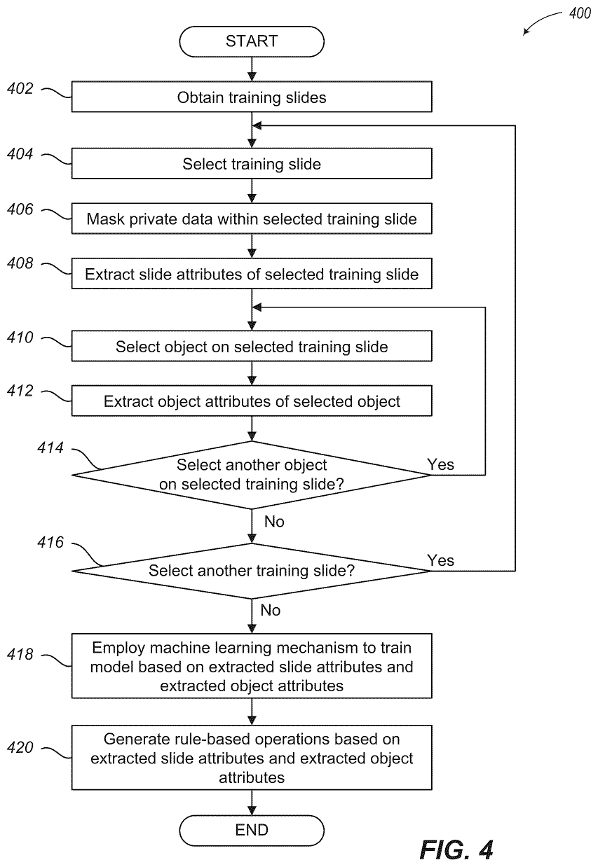

The operation of certain aspects will now be described with respect to FIGS. 3 and 4. The functionality of processes 300 and 400 described in conjunction with FIGS. 3 and 4, respectively, may be implemented by one or more processors or executed via circuitry on one or more computing devices, such as automated slide modification server 102 in FIG. 1.

FIG. 3 illustrates a logical flow diagram showing one embodiment of an overview process 300 for automatically formatting and generating slide in accordance with embodiments described herein.

Process 300 begins, after a start block, at block 302, where one or more rule-based operations are defined. In various embodiments, the rule-based operations may include user or administrative defined or set operations that can be applied to one or more slides or a specific theme. Accordingly, one or more rule-based operations may be defined for each separate theme of a plurality of themes. In this way, separate rule-based operations are set for separate themes. The rule-based operations may include specific rules for enhancing or changing the resolution of images, removing backgrounds on images, changing backgrounds on images to specific colors or textures (or other predefined image backgrounds), adjusting image proportions, cropping images for individual person headshots, selecting a specific color or color scheme for text or other slide objects, selecting text or object alignments or distributions, selecting functions to perform on one or more objects (e.g., changing paragraphs to bullet points), defining object or slide transitions, or other operations that can be performed or applied to a target slide or objects on a target slide. In some embodiments, the rule-based operations may be learned or generated from slide attributes or object attributes, or both, extracted from training slides, such as described in process 400 in FIG. 4.

Process 300 proceeds after block 302 to block 304, where a target presentation slide is selected. In at least one embodiment, the target slide may be current slide being modified or edited by the user. In other embodiments, the target slide may be selected by a user from a plurality of slide thumbnails or a plurality of slide previews.

In some other embodiments, the target slide may be a blank slide or information that is to be presented on a new slide. In this way, the system can generate a new slide or fill in a black slide using the rule-based operations or a trained machine learning model, as described herein.

Process 300 continues after block 304 at block 306, where a theme for the target slide is selected. The theme may be based on the type of content or information presented in the target slide (e.g., accounting data, research data, business information, etc.), a type of audience for the target slide, a desired mood for the target slide (e.g., a theme that evokes happy feelings in the audience), or other subject or topic. In various embodiments, the theme may be selected to be the same or have a common thread among a plurality of slides that include the target slide.

In some embodiments, the user may select the theme, such as via a dropdown menu showing a plurality of possible themes. In other embodiments, a trained machine learning model may be employed to select the theme. This model may be trained using a plurality of training slides directed to different themes. In some embodiments, the model may be trained based on content or information in the training slides. In this way, the target slide is used as input to the model. In other embodiments, the model may be trained based on training slides directed to different types of audiences, training slides directed to different moods, etc. In this way, the user can select the audience type or mood, which is used as input to the model.

In some embodiments, the theme may be automatically selected via the model. In other embodiments, the model may output or recommend one or more possible themes to the user, from which the user can select the theme.

Process 300 proceeds after block 306 to decision block 308, where a determination is made whether to employ rule-based operations or a trained machine learning model on the target slide. In some embodiments, this determination may be made based on user input. For example, the user may select a button that indicates the rule-based operations should be employed. Conversely, the user may select a button that indicates the trained machine learning model should be employed. In yet other embodiments, a user may select specific actions to be performed on the target slide, and the system determines whether the rule-based operations should be used to perform those user-selected actions or if the trained machine learning model should be employed to perform those user-selected actions. In other embodiments, this determination may be made based on the selected theme. If rule-based operations are employed, process 300 flows to block 310, but if a trained machine learning model is employed, process 300 flows to block 312.

In various embodiments, both rule-based operations and a trained machine learning model may be employed on the target slide. In some embodiments, process 300 may perform the rule-based operations to modify the target slide in parallel with the employment of the trained machine learning model to modify the target slide. In other embodiments, process 300 may perform the rule-based operations to modify the target slide prior to (e.g., sequentially) employing the trained machine learning model to modify the target slide. In yet other embodiments, process 300 may employing the trained machine learning model to modify the target slide prior to (e.g., sequentially) performing the rule-based operations to modify the target slide.

If, at decision block 308, rule-based operations are to be performed, process 300 flows from decision block 308 to block 310. At block 310, one or more rule-based operations are selected based on the selected theme. These selected rule-based operations may include formatting tasks such as titling specific objects on the target slide, setting a specific bullet point structure, arranging a footnote in a specific area on the target slide, etc.

Process 300 proceeds from block 310 to block 311, where the selected rule-based operations are performed on the target slide. In various embodiments, the target slide or one or more objects on the target slide are automatically modified in accordance with the selected rule-based operations. For example, one of the selected rule-based operations may be to set the position of a footnote on a slide to be 10 mm from the bottom of the slide. If there is a footnote object present on the target slide, then the footnote object may be positioned to be 10 mm from the bottom of the target slide.

One or more of the selected rule-based operations may be performed on the target slide itself, such as setting margins for the target slide. Likewise, one or more of the selected rule-based operations may be performed on one or more objects on the target slide. In some embodiments, a subset, but not all, of the selected rule-based operations may be performed on the target slide or on a specific object. Similarly, some selected rule-based operations may be performed on one object (or on the target slide itself), but not on another object based on various characteristics of the objects and the rule-based operations. For example, one rule-based operation may be performed on an image object, but that same rule-base operation may not be performed on a text object or on the target slide as a whole. As another example, one rule-based operation may be performed on the target slide as a whole, but not on the individual objects on the target slide. As yet another example, one rule-based operation may be performed on each object on the target slide.

After the target slide has been automatically modified by performing the selected rule-based operations at block 311, process 300 proceeds to decision block 314.

If, at decision block 308, a trained machine learning model is to be employed, then process 300 flows from decision block 308 to block 312. At block 312, one or more trained machine learning models are employed on the target slide to output at least one modification for the target slide. In some embodiments, the theme may be part of the input into the trained machine learning model. In other embodiments, a plurality of machine learning models may be trained for different themes, and the theme is used to select the appropriate trained machine learning model.

In some embodiments, the target slide itself is used as input to the model, which then outputs one or more changes or recommendations to modify the target slide. These modifications may include formatting changes to specific objects or types of objects on the target slide, setting a background for the target slide, modifying the position of objects on the target slide, adding images or charts to the target slide, etc.

In some embodiments, the user may select additional actions to perform on the target slide, which may also be used to select the model or as input into the model. For example, the user may select to change the color scheme of the target slide. This user selection can be used as input into the model such that the model outputs a recommended color scheme for the selected theme.

Process 300 proceeds after block 312 to block 313, where the at least one modification recommended by the trained machine learning model is employed on the target slide. In some embodiments, one or more modifications may be automatically performed on the target slide. In other embodiments, the user may be presented with one or more recommended modifications from which the user can select which modifications are to be performed.

Examples of the modifications may include enhancing image resolution, removing image backgrounds, adjusting image proportions, cropping images for individual person headshots, selecting a color or color scheme for text or other slide objects, selecting text or object alignments or distributions, selecting functions to perform on one or more objects (e.g., changing paragraphs to bullet points), or other modifications to apply to a target slide or objects on a target slide.

After block 312, process 300 proceeds to decision block 314.

At decision block 314, a determination is made whether another target slide is selected. In various embodiments, the user may select whether a single slide is modified using embodiments described herein or if a plurality of slides are modified using embodiments described herein. If another target slide is to be selected, then process 300 loops to block 304 to select another target slide; otherwise, process 300 flows to decision block 316.

At decision block 316, a determination is made whether additional user modifications have been made to any of the slides after the machine learning model or the rule-based operations are employed. Such modification could include changing the formatting of a slide, changing the formatting of an object on a slide, adjusting a position of an object on a slide, changing an object itself on a slide, etc. In other embodiments, the user may provide confirmation of the output or modifications made by employing the trained machine learning model. If the user modified a slide, process 300 proceeds to block 318; otherwise, process 300 terminates or returns to a calling process to perform other actions. In some embodiments, process 300 may proceed from decision block 316 to block 318 in response to various different user inputs, including confirmation of accurate slides, indications of failed slides, modifications to slides, etc.

At block 318, the machine learning model is re-trained based on the user modification or by providing a user modified final output slide data set. In various embodiments, process 400 in FIG. 4 may be used to retrain the model, but with the user modifications as additional input to the training data.

After block 318, process 300 terminations or returns to a calling process to perform other actions.

FIG. 4 illustrates a logical flow diagram showing one embodiment of a process 400 for employing machine learning to train a model to automatically format and generate slides in accordance with embodiments described herein.

Process 400 begins, after a start block, at block 402 where a plurality of training sliders are obtained. In various embodiments, the training slides may be selected to train the machine learning model for a specific purpose. For example, all the training slides may be directed to accounting data such that the machine learning model is trained for an accounting theme.

Process 400 proceeds after block 402 to block 404, where a training slide is selected. In various embodiments, each training slide is selected in an orderly manner so that all obtained training slides are pre-processed prior to training the machine learning model.

Process 400 continues after block 404 at block 406, where private or other sensitive data within the selected training slide are masked. Such masking may include removing, names of people, names of products, company names, specific numbers (e.g., dollar amounts, addresses, sales numbers, etc.), etc. In some embodiments, the removed data may be replaced with a specific placeholder to help in training the model. For example, each company name may be replaced with the placeholder “SAMPLE ACME, INC.”

Process 400 proceeds next after block 406 to block 408, where slides attributes are extracted from the selected training slide. Examples of the slide attributes may include: a size of the slide, margins of the slide, an applied template, an applied color scheme, or other characteristics of the selected training slide.

Process 400 continues next after block 408 at block 410, where an object on the selected training slide is selected. In various embodiments, each object on the selected training slide is selected in an orderly manner so that all objects on the selected training slide are pre-processed prior to training the machine learning model. Examples of objects may include images, text boxes, charts, tables, symbols, icons, footnotes, comment areas, or other visible or transparent items positioned on or associated with the selected training slide.

Process 400 proceeds after block 410 to block 412, where object attributes are extracted from the selected object. Examples of object attributes may include: a position of the selected object on the selected training slide, text color, background color, size of the selected object, bullet or number formatting associated with the selected object, type of object (e.g., image, text box, table, etc.), text font or typeface, text formatting, or other characteristics of the selected object.

Process 400 continues after block 412 at decision block 414, where a determination is made whether to select another object on the selected training slide. In some embodiments, each object in the target training slide is selected. But in other embodiments, if the machine learning model is being trained for a specific type of object, then each object of the specific type are selected. If another object is to be selected on the selected training slide, then process 400 loops to block 410 to select another object and extract its object attributes; otherwise, process 400 flows to decision block 416.

At decision block 416, a determination is made whether to select another training slide. In some embodiments, each training slide of the received training slides is selected. If another training slide is to be selected, then process 400 loops to block 404 to select another block, extract slide attributes from that slide, and extract object attributes from the objects of that slide. If no other training slides are to be selected, then process 400 flows to block 418.

At block 418, a machine learning mechanism is employed to train or generate a model based on the extracted slide attributes and the extracted object attributes. In various embodiments, the machine learning mechanism is fed with the extracted attributes to generate a model that is a mathematical representation of relationships between the attributes. In various embodiments, the model is iteratively updated until it reaches a defined accuracy threshold.

In some embodiments, the model may be refined and retrained using additional training data or feedback. Such feedback, for example, may include user modifications to one or more slides or objects on a slide after the model is employed via process 300 in FIG. 3. In various embodiments, a user may provide confirmation indicating that the output or modified slides are accurate. In other embodiments, the user may identify a failed slide indicating that the modifications made by employing the trained machine learn model were not accurate. In yet other embodiments, the user may explicitly modify one or more parameter or characteristic of a slide or object on a slide. These user inputs (or a user modified final output slide data set) may be used as additional training data to refine or retrain the model.

Process 400 proceeds after block 418 to block 420, where one or more rule-based operations may be generated based on the extracted slide attributes and the extracted object attributes. In various embodiments, these rule-based operations may include: template-specific color schemes, specific font or bullet styles, or other types of characteristics. In some embodiments, these rule-based operations may be part of or output from the machine learning mechanism. In other embodiments, another machine learning mechanism may be employed to learn or generate the rule-based operations. In yet other embodiments, a user or administrator may select or define the rule-based operations based on one or more of the extracted slide attributes or one or more of the extracted object attributes, or some combination thereof.

After block 420, process 400 terminates or otherwise returns to a calling process to perform other actions.

As described herein, one or more machine learning models may be trained to output or predicted different slide themes, object attributes, slide attributes, or other slide or object characteristics. Accordingly, process 400 may be repeated with separate training slides that are customized for the specific characteristic in which the machine learning model is trained.

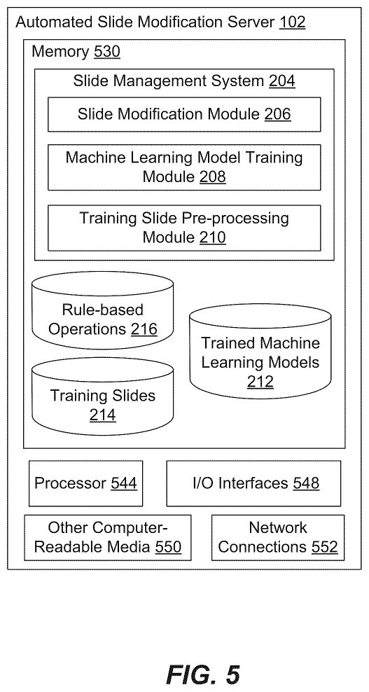

FIG. 5 shows a system diagram that describes one implementation of computing systems for implementing embodiments described herein, including the automated slide modification server 102.

The automated slide modification server 102 is a computing system that trains and employs a machine learning model to predict and automatically modify presentation slides for a user, as described herein. One or more special-purpose computing systems may be used to implement the automated slide modification server 102. Accordingly, various embodiments described herein may be implemented in software, hardware, firmware, or in some combination thereof. The automated slide modification server 102 may include memory 530, processor 544 I/O interfaces 548, other computer-readable media 550, and network connections 552.

Processor 544 may include one or more central processing units, circuitry, or other computing components or units—collectively referred to as a processor or one or more processors—that are configured to performed embodiments herein or to execute computer instructions to perform embodiments described herein. In some embodiments, a single processor may operate individually to perform embodiments described herein. In other embodiments, a plurality of processors may operate to collectively perform embodiments described herein, such that one or more processors may operate to perform some, but not all, of the embodiments described herein.

Memory 530 may include one or more various types of non-volatile and/or volatile storage technologies. Examples of memory 530 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 530 may be utilized to store information, including computer-readable instructions that are utilized by Processor 544 to perform actions, including embodiments described herein.

Memory 530 may have stored thereon slide management system 204, which is configured to perform embodiments described herein. In various embodiments, the slide management system 204 may include slide modification module 206, machine learning model training module 208, and training slide pre-processing module 210. The slide modification module 206 is configured to select and employ a previously trained machine learning model on a target slide to automatically modify or generate a presentation slide, as described herein. The machine learning model training module 208 is configured to train one or more machine learning models from a plurality of training slides using one or more machine learning or artificial intelligence mechanisms, as described herein. And the training slide pre-processing module 210 is configured to prepare the training slides for use by the machine learning model training module 208, as described herein.

Memory 530 may store rule-based operations 216, training slides 214, and trained machine learning models 212. In some embodiments, the memory 530 may also store other programs and data (e.g., operating systems, slide development applications, etc.).

Network connections 552 are configured to communicate with other computing devices, such as user devices 108 in FIG. 1. In various embodiments, the network connections 552 include transmitters and receivers (not illustrated) to send and receive data as described herein. I/O interfaces 548 may include one or more data input or output interfaces, video or display interfaces, or other input/output interfaces. Other computer-readable media 552 may include other types of stationary or removable computer-readable media, such as removable flash drives, external hard drives, or the like.

The following is a summarization of the claims as filed.

A method may be summarized as comprising: selecting a target presentation slide; selecting a theme for the target presentation slide; employing a trained machine learning model on the target presentation slide based on the theme to generate at least one recommended modification to the target presentation slide; and modifying the target presentation slide based on the at least one recommended modification.

Modifying the target presentation slide may include generating a new slide to include at least one object based on the at least one recommended modification.

The method may further comprise: defining a plurality of rule-based operations; selecting at least one rule-based operation from the plurality of rule-based operations based on the selected theme; and performing at least one selected rule-based operation to automatically modify the target presentation slide. In some embodiments, defining the plurality of rule-based operations may include: receiving a plurality of training slides; extracting slide attributes from the plurality of training slides; and generating the plurality of rule-based operations based on the extracted slide attributes. In other embodiments, defining the plurality of rule-based operations may include: receiving a plurality of training slides; extracting object attributes from each object on the plurality of training slides; and generating the plurality of rule-based operations based on the extracted object attributes.

The method may further comprise: receiving at least one user-modification to the modified target presentation slide; and retraining the trained machine learning model based on the at least one user-modification.

The method may further comprise: receiving a plurality of training slides; extracting slide attributes from the plurality of training slides; and generating the trained machine learning model based on the extracted slide attributes.

The method may further comprise: receiving a plurality of training slides; extracting object attributes from each object on the plurality of training slides; and generating the trained machine learning model based on the extracted object attributes.

The method may further comprise: receiving a plurality of training slides; masking private data from the plurality of training slides; and employing a machine learning mechanism on the plurality of training slides to generate the trained machine learning model.

A computing system may be summarized as comprising a memory configured to store computer instructions; and a processor configured to execute the computer instructions to: employ a machine learning mechanism on a plurality of training slides to generate a trained machine learning model; receive a target presentation slide; obtain a theme for the target presentation slide; employ a trained machine learning model on the target presentation slide based on the theme to generate at least one recommended modification to the target presentation slide; and modify the target presentation slide based on the at least one recommended modification.

The processor of the computing system may modify the target presentation slide by further executing the computer instructions to generate a new slide to include at least one object based on the at least one recommended modification.

The processor of the computing system may further execute the computer instructions to: define a plurality of rule-based operations; select at least one rule-based operation from the plurality of rule-based operations based on the selected theme; and perform at least one selected rule-based operation to automatically modify the target presentation slide. In some embodiments, the processor of the computing system may define the plurality of rule-based operations by further executing the computer instructions to: receive a plurality of training slides; identify slide attributes from the plurality of training slides; and generate the plurality of rule-based operations based on the identified slide attributes. In other embodiments, the processor of the computing system may define the plurality of rule-based operations by further executing the computer instructions to: receive a plurality of training slides; identify object attributes from each object on the plurality of training slides; and generate the plurality of rule-based operations based on the identified object attributes.

The processor of the computing system may further execute the computer instructions to: receive at least one user-modification to the modified target presentation slide; and retrain the trained machine learning model based on the at least one user-modification.

The processor of the computing system may further execute the computer instructions to: receive a plurality of training slides; identify slide attributes from the plurality of training slides; and generate the trained machine learning model based on the identified slide attributes.

The processor of the computing system may further execute the computer instructions to: receive a plurality of training slides; identify object attributes from each object on the plurality of training slides; and generate the trained machine learning model based on the identified object attributes.

The processor of the computing system may further execute the computer instructions to: receive a plurality of training slides; remove private data from the plurality of training slides; and employ a machine learning mechanism on the plurality of training slides to generate the trained machine learning model.

A non-transitory computer-readable storage medium may be summarized as storing instructions that, when executed by a processor in a computing system, cause the processor to perform actions. The actions comprising: defining a plurality of rule-based operations; selecting a plurality of target presentation slides; selecting a theme for the plurality of target presentation slides; determining whether at least one rule-based operation or a trained machine learning model is to be employed on the plurality of target presentation slides. In response to determining that the at least one rule-based operation is to be employed on the plurality of target presentation slides: selecting the at least one rule-based operation from the plurality of rule-based operations based on the selected theme; and performing the at least one selected rule-based operation to automatically modify the target presentation slide. And in response to determining that the trained machine learning model is to be employed on the plurality of target presentation slides: employing the trained machine learning model on the target presentation slide based on the theme to generate at least one recommended modification to the target presentation slide; and modifying the target presentation slide based on the at least one recommended modification.

The instructions, when executed by the processor, may cause the processor to perform further actions, the further actions comprising: receiving a plurality of training slides; masking private data from the plurality of training slides; extracting slide attributes from the plurality of training slides; extracting object attributes from each object on the plurality of training slides; and generating the trained machine learning model based on the extracted object attributes and the extracted slide attributes.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
selecting a target presentation slide;
selecting a theme for the target presentation slide;
employing a trained machine learning model on the target presentation slide based on the theme to generate at least one recommended modification to the target presentation slide; and
modifying the target presentation slide based on the at least one recommended modification.

2. The method of claim 1, wherein modifying the target presentation slide includes:
generating a new slide to include at least one object based on the at least one recommended modification.

3. The method of claim 1, further comprising:
defining a plurality of rule-based operations;
selecting at least one rule-based operation from the plurality of rule-based operations based on the selected theme; and
performing at least one selected rule-based operation to automatically modify the target presentation slide.

4. The method of claim 3, wherein defining the plurality of rule-based operations includes:
receiving a plurality of training slides;
extracting slide attributes from the plurality of training slides; and
generating the plurality of rule-based operations based on the extracted slide attributes.

5. The method of claim 3, wherein defining the plurality of rule-based operations includes:
receiving a plurality of training slides;
extracting object attributes from each object on the plurality of training slides; and
generating the plurality of rule-based operations based on the extracted object attributes.

6. The method of claim 1, further comprising:
receiving at least one user-modification to the modified target presentation slide; and
retraining the trained machine learning model based on the at least one user-modification.

7. The method of claim 1, further comprising:
receiving a plurality of training slides;
extracting slide attributes from the plurality of training slides; and
generating the trained machine learning model based on the extracted slide attributes.

8. The method of claim 1, further comprising:
receiving a plurality of training slides;
extracting object attributes from each object on the plurality of training slides; and
generating the trained machine learning model based on the extracted object attributes.

9. The method of claim 1, further comprising:
receiving a plurality of training slides;
masking private data from the plurality of training slides; and
employing a machine learning mechanism on the plurality of training slides to generate the trained machine learning model.

10. A computing system, comprising:
a memory configured to store computer instructions; and
a processor configured to execute the computer instructions to:
employ a machine learning mechanism on a plurality of training slides to generate a trained machine learning model;
receive a target presentation slide;
obtain a theme for the target presentation slide;
employ a trained machine learning model on the target presentation slide based on the theme to generate at least one recommended modification to the target presentation slide; and
modify the target presentation slide based on the at least one recommended modification.

11. The computing system of claim 10, wherein the processor modifies the target presentation slide by further executing the computer instructions to:
generate a new slide to include at least one object based on the at least one recommended modification.

12. The computing system of claim 10, wherein the processor further executes the computer instructions to:
define a plurality of rule-based operations;
select at least one rule-based operation from the plurality of rule-based operations based on the selected theme; and
perform at least one selected rule-based operation to automatically modify the target presentation slide.

13. The computing system of claim 12, wherein the processor defines the plurality of rule-based operations by further executing the computer instructions to:
receive a plurality of training slides;
identify slide attributes from the plurality of training slides; and
generate the plurality of rule-based operations based on the identified slide attributes.

14. The computing system of claim 12, wherein the processor defines the plurality of rule-based operations by further executing the computer instructions to:
receive a plurality of training slides;
identify object attributes from each object on the plurality of training slides; and
generate the plurality of rule-based operations based on the identified object attributes.

15. The computing system of claim 10, wherein the processor further executes the computer instructions to:
receive at least one user-modification to the modified target presentation slide; and
retrain the trained machine learning model based on the at least one user-modification.

16. The computing system of claim 10, wherein the processor further executes the computer instructions to:
receive a plurality of training slides;
identify slide attributes from the plurality of training slides; and
generate the trained machine learning model based on the identified slide attributes.

17. The computing system of claim 10, wherein the processor further executes the computer instructions to:
receive a plurality of training slides;
identify object attributes from each object on the plurality of training slides; and
generate the trained machine learning model based on the identified object attributes.

18. The computing system of claim 10, wherein the processor further executes the computer instructions to:
receive a plurality of training slides;
remove private data from the plurality of training slides; and
employ a machine learning mechanism on the plurality of training slides to generate the trained machine learning model.

19. A non-transitory computer-readable storage medium that stores instructions that, when executed by a processor in a computing system, cause the processor to perform actions, the actions comprising:
defining a plurality of rule-based operations;
selecting a plurality of target presentation slides;
selecting a theme for the plurality of target presentation slides;
determining whether at least one rule-based operation or a trained machine learning model is to be employed on the plurality of target presentation slides:
in response to determining that the at least one rule-based operation is to be employed on the plurality of target presentation slides:
selecting the at least one rule-based operation from the plurality of rule-based operations based on the selected theme; and
performing the at least one selected rule-based operation to automatically modify the target presentation slide; and
in response to determining that the trained machine learning model is to be employed on the plurality of target presentation slides:
employing the trained machine learning model on the target presentation slide based on the theme to generate at least one recommended modification to the target presentation slide; and
modifying the target presentation slide based on the at least one recommended modification.

20. The non-transitory computer-readable storage medium of claim 15, wherein the instructions, when executed by the processor, cause the processor to perform further actions, the further actions comprising:
receiving a plurality of training slides;
masking private data from the plurality of training slides;
extracting slide attributes from the plurality of training slides;
extracting object attributes from each object on the plurality of training slides; and
generating the trained machine learning model based on the extracted object attributes and the extracted slide attributes.
